(19) United States
(12) Patent Application Publication
(10) Pub. No.: US 2013/0240084 A1
(43) Pub. Date: Sep. 19, 2013

(54) VENDING MACHINE FOR REFILLING A CONTAINER WITH LIQUID

(71) Applicants: Bradley Allen Carter, Nova, OH (US); Neil Robert Bumgarner, Point Pleasant, WV (US)

(72) Inventors: Bradley Allen Carter, Nova, OH (US); Neil Robert Bumgarner, Point Pleasant, WV (US)

(21) Appl. No.: 13/798,487

(22) Filed: Mar. 13, 2013

Related U.S. Application Data
(60) Provisional application No. 61/610,190, filed on Mar. 13, 2012.

(51) Int. Cl. B67D 7/34

(52) U.S. Cl. CPC B67D 7/346
USPC 141/94; 141/98

(57) ABSTRACT

A vending machine for refilling a bottle with liquid is provided. The vending machine includes a refilling station that is configured to receive and refill only bottles from a set of bottles having the same configuration with the liquid. The vending machine includes a liquid source for supplying the liquid and a payment acceptor that is configured to accept payment to refill the bottle with liquid from the liquid source. A respective bottle from the set of bottles is refilled with liquid from the liquid source when received by the filling station in response to the payment acceptor receiving payment to refill the bottle with liquid from the liquid source.

### CROSS-REFERENCE TO RELATED APPLICATIONS

This application claims benefit under 35 U.S.C. §119(e) of Provisional Application No. 61/610,190 filed Mar. 13, 2012, the disclosure of which is incorporated herein by reference in its entirety.

### BACKGROUND

It has been estimated that Americans drink about thirty gallons per person of bottled water per year. Unfortunately, this consumption has created environmental concerns. The plastic bottles have created a high volume of waste that has overflowed landfills and littered into oceans, rivers, streams, and on land. Plastic bottles further take centuries to decompose and if they are incinerated, toxic byproducts, such as chlorine gas and ash containing heavy metals, are released into the atmosphere. Also, the bottled water requires millions of barrels of oil per year and the transportation of the bottled water from its source to stores releases thousands of tons of carbon dioxide.

### SUMMARY

The following is a brief summary of subject matter that is described in greater detail herein. This summary is not intended to be limiting as to the scope of the claims. A vending machine for refilling a bottle with liquid is provided to help solve the above-mentioned problems. The vending machine includes a refilling station that is configured to receive and refill only a bottle from a set of bottles having the same configuration with the liquid. The vending machine includes a liquid source for supplying the liquid and a payment acceptor that is configured to accept payment to refill the bottle with liquid from the liquid source. A respective bottle from the set of bottles is refilled with liquid from the liquid source when received by the filling station in response to the payment acceptor receiving payment to refill the bottle with liquid from the liquid source.

Other aspects will be appreciated upon reading and understanding the attached figures and description.

### BRIEF DESCRIPTION OF THE DRAWINGS

FIG. 1 is a front schematic view of the vending machine according to an exemplary embodiment.

FIG. 2A is a front perspective view of a portion of the vending machine of FIG. 1 showing the refilling bottle station and related elements with the door in the open position.

FIG. 2B is a view similar to FIG. 2A but with the door in the close position and a bottle positioned in the refilling station.

FIG. 3 is a front perspective view of a portion of the bottle station with the door in the open position.

FIG. 4 is a front perspective view of a portion of the vending machine of FIG. 1 showing the refilling bottle station and gate and related elements with portions removed for illustrative purposes.

FIG. 5 is a view similar to FIG. 4 but with the bottle inserted in the recess of the platform of the refilling bottle station and the door in the closed position.

FIG. 6 is a front schematic view of the interior of the vending machine of FIG. 1.

FIG. 7 is a side view of the bottle used in the vending machine of FIG. 1.

FIG. 8 is a bottom view of the bottle of FIG. 7.

FIG. 9 is a front schematic view of the lid of the bottle of FIG. 5.

FIG. 10 is a block diagram of elements connected to a controller of the vending machine of FIG. 1.

### DETAILED DESCRIPTION

Various technologies pertaining to the embodiments will now be described with reference to the drawings, where like reference numerals represent like elements throughout. In addition, several functional block diagrams of example systems are illustrated and described herein for purposes of explanation; however, it is to be understood that functionality that is described as being carried out by certain system components and devices may be performed by multiple components and devices. Similarly, for instance, a component/device may be configured to perform functionality that is described as being carried out by multiple components/devices.

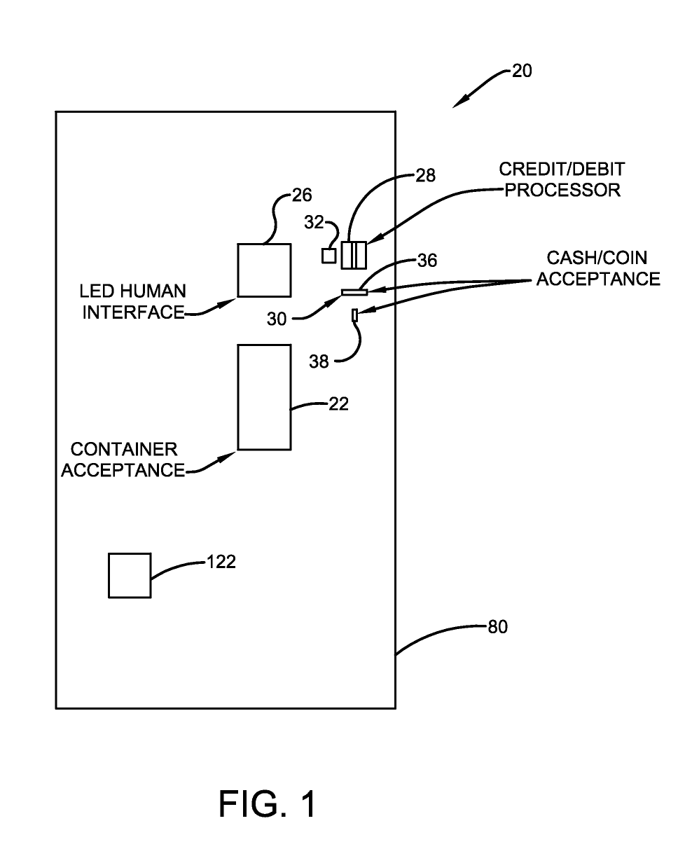

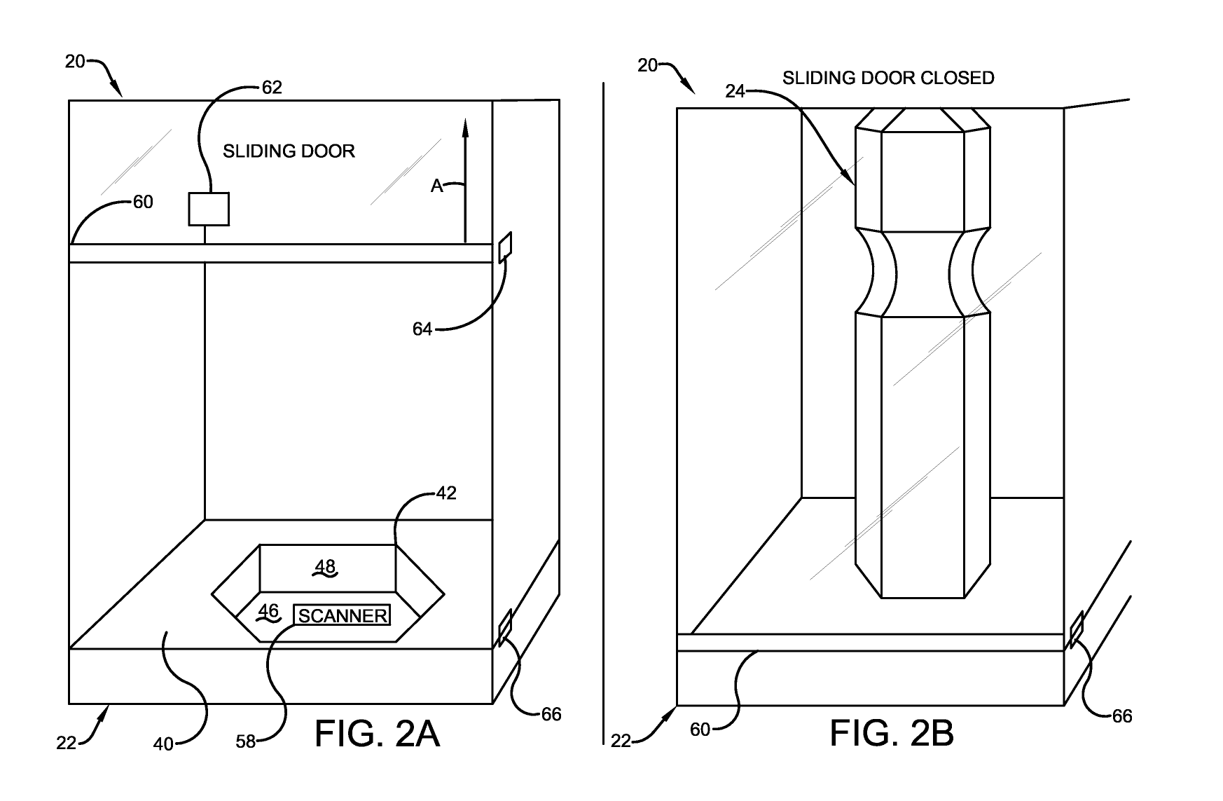

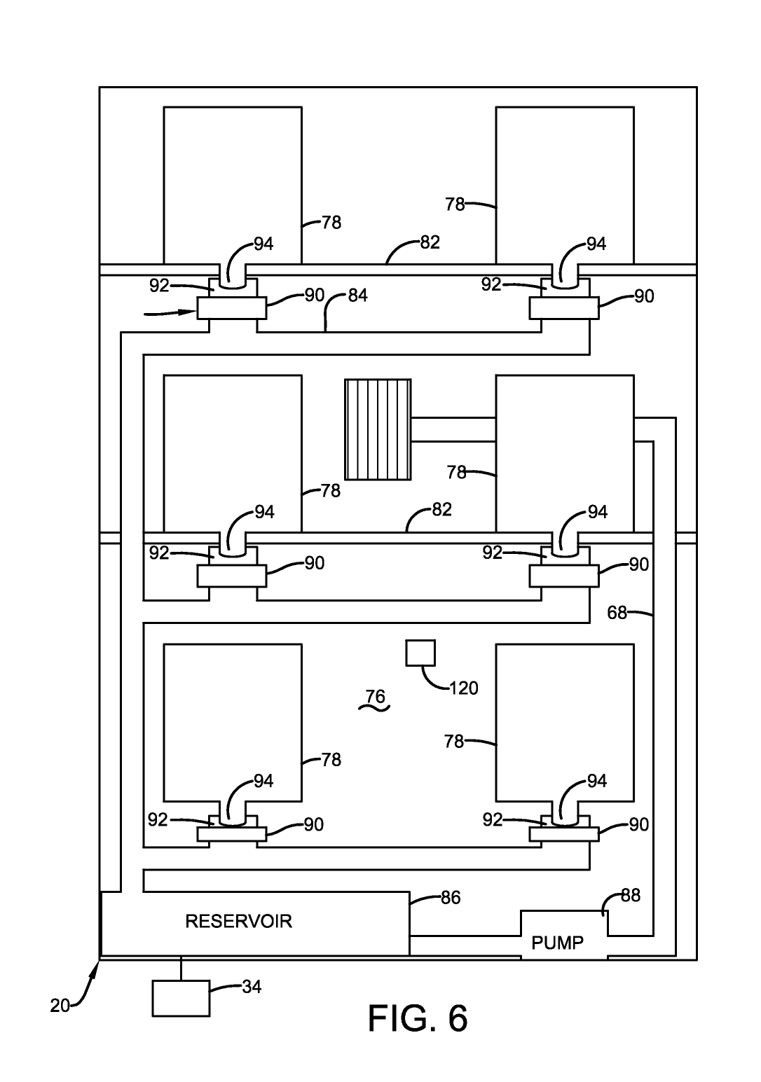

Referring to FIG. 1, the water bottle refilling vending machine 20 includes a recess or pocket that defines a bottle refilling station 22 that is configured to accept a water bottle 24 (FIGS. 2B, 5, and 7), a display or digital interface 26, a card reader 28, and currency acceptor 30. The card reader 28 is configured to read credit cards, debit cards or other types of payment cards for payment of the fee for refilling the bottle 24 with water. The card reader 28 may be a slide or swipe type reader, a dip type reader or other suitable type of card reader. The card reader 28 may include a slot for accepting the card and a processor 32 for processing the information. The vending machine 20 also includes a wireless internet connection 34 (FIG. 6) to facilitate the credit card payment transaction. The currency acceptor 30 may be configured to accept bills and coins of various types of currency to be used as payment of the fee for refilling the bottle 24 with water. For example, the currency acceptor 30 may have a slot 36 that accepts bills such as one dollar bills and a coin slot 38, quarters, dimes and nickels. The machine may have other types of payment acceptors such as one that accepts checks as payment.

The display or digital interface 26 may be configured to display messages to prompt or direct customers through the purchase of refilling their water bottle 24 with water. The interface 26 may include a touch screen display to allow customer to interact with the interface. Alternatively, or in addition, control buttons may be provided near the interface for the customers to use. The interface 26 may also be an LED interface. The display may display advertisements or prompt customers to sign up to purchase goods or services.

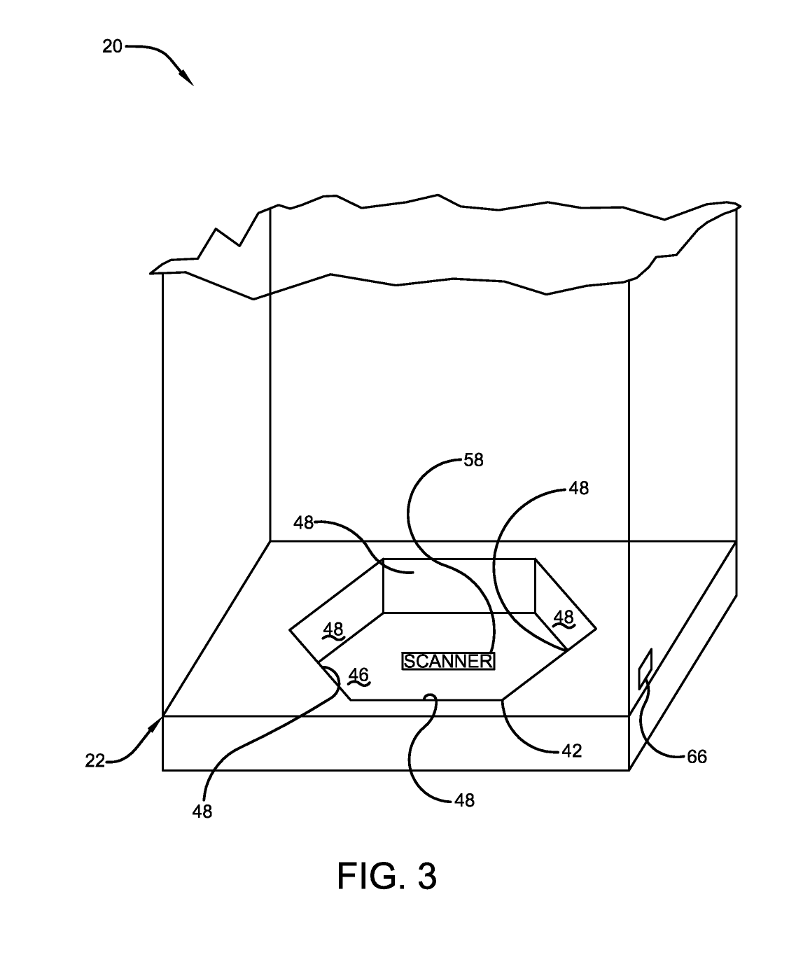

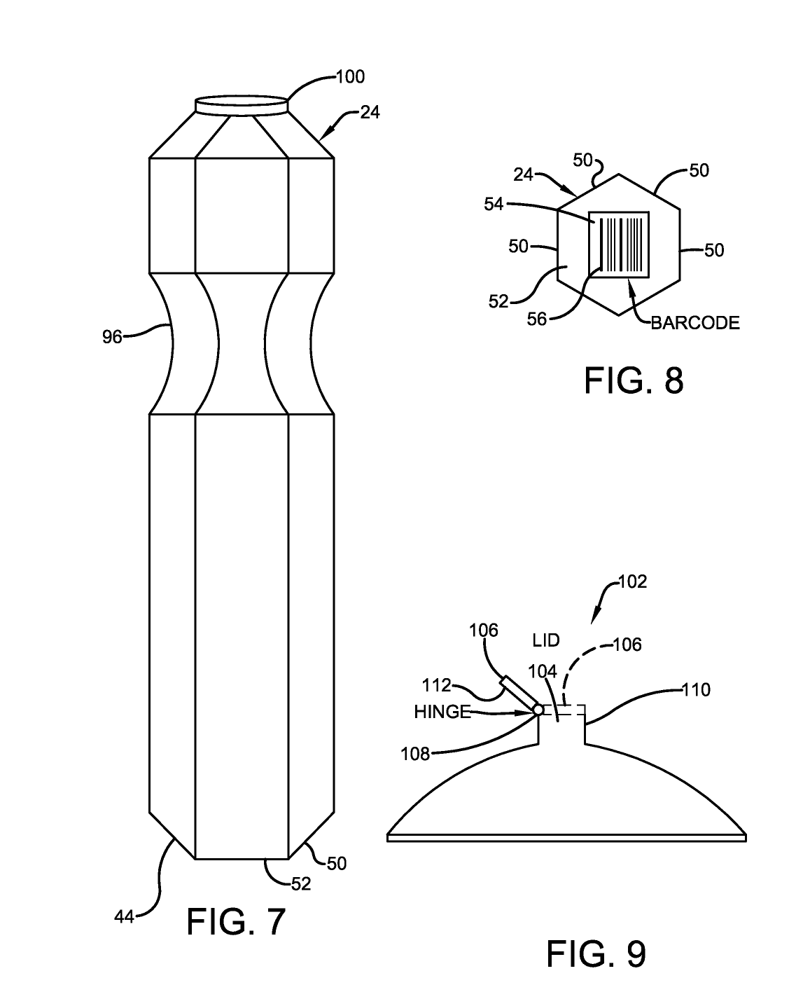

Referring to FIGS. 2A, 2B, and 3, the bottle refilling station 22 includes a platform 40 on the bottom upon which the bottle 24 rests during refilling of the bottle 24 with water. As seen in FIGS. 2A and 3, the platform includes a recess or inset 42 that is shaped to slidingly and snugly fit a similarly shaped lower portion 44 (FIG. 7) of the bottle 24. In this exemplary embodiment, the recess 42 is defined by a bottom face 46 and six side faces 48. The side faces 48 of the recess 42 may slope downwardly and radially inwardly. The recess 42 is hexagonally shaped to match and slidingly receive a hexagonally shaped lower portion 44 of the bottle 24 as seen in FIGS. 2A, 2B, 5, and 7. The lower portion 44 of the bottle converges or tapers towards bottom end 52 to define six beveled side faces 50 that match the six side faces 48 of the recess 42. The hexagonal shape of the recess and lower portion also prevents rotational movement of the bottle about its longitudinal axis. Other suitable ways of holding the bottle in the bottle refilling station 22 may be used.

As seen in FIG. 8, each water bottle 24 from a set of similarly shaped water bottles 24 includes a bar code label 54 that is attached by adhesive to bottom end 52 of the bottle 24. Alternatively, the bar code 56 may be imprinted on the bottom end 52 or provided thereon by other suitable ways. A barcode scanner 58 (FIGS. 2A and 3) is provided at the bottom face 46 of the recess 42 and is configured to read the bar code 56 on the bottom end 52 of the bottle 24, when the bottle 24 is inserted in the recess 42, to identify or verify and ensure that the water bottle 24 is from the set of bottles that are only permitted to be used in this system. The set of bottles maybe similarly shaped or have other similar features that identify them as belonging to the set. Alternatively, the vending machine may be configured to receive a variety of bottles of various shapes or configurations. A drain covered by a screen may be provided under the platform to drain water that may be spilled during the refilling process.

A sliding door 60 (FIGS. 2A, 2B, 4, and 5) is provided on the front of the bottle refilling station 22 and slidingly connected to the front of the vending machine 20. The door 60 may be made of transparent plastic or other suitable material for viewing inside the bottle refilling station 22. The door 60 slides vertically upward (see arrow A) in the open position (FIG. 2A) to allow the bottle 24 to be placed in or removed from the recess, and vertically downward in the closed position (FIG. 2B) to cover the bottle refilling station 22. The door 60 is normally in the closed position when the vending machine 20 is not refilling a bottle 24 to prevent dirt or debris from entering the bottle refilling station 22 so as to ensure that the sanitary conditions are maintained in the bottle refilling station 22. The door 60 may be operatively connected to a door actuator 62 that operates to move the door 60 between the open and close positions in response to certain conditions. Upper and lower door switches 64, 66 (FIGS. 2A and 2B) are provided on respective upper and lower ends of the bottle refilling station 22 to detect the position of the door 60. Specifically, the upper door switch 64 detects when the door 60 is moved upward to the open position and sends a signal to programmable logic controller 118 indicating this door position. The lower door switch 66 detects when the door is in the closed and sends a signal to the controller 118 indicating this door position. Alternatively, the door 60 may be moved to the open and closed manually by the user. Also, the door 60 may be alternatively hinged or otherwise pivotally connected to the front of the vending machine 20.

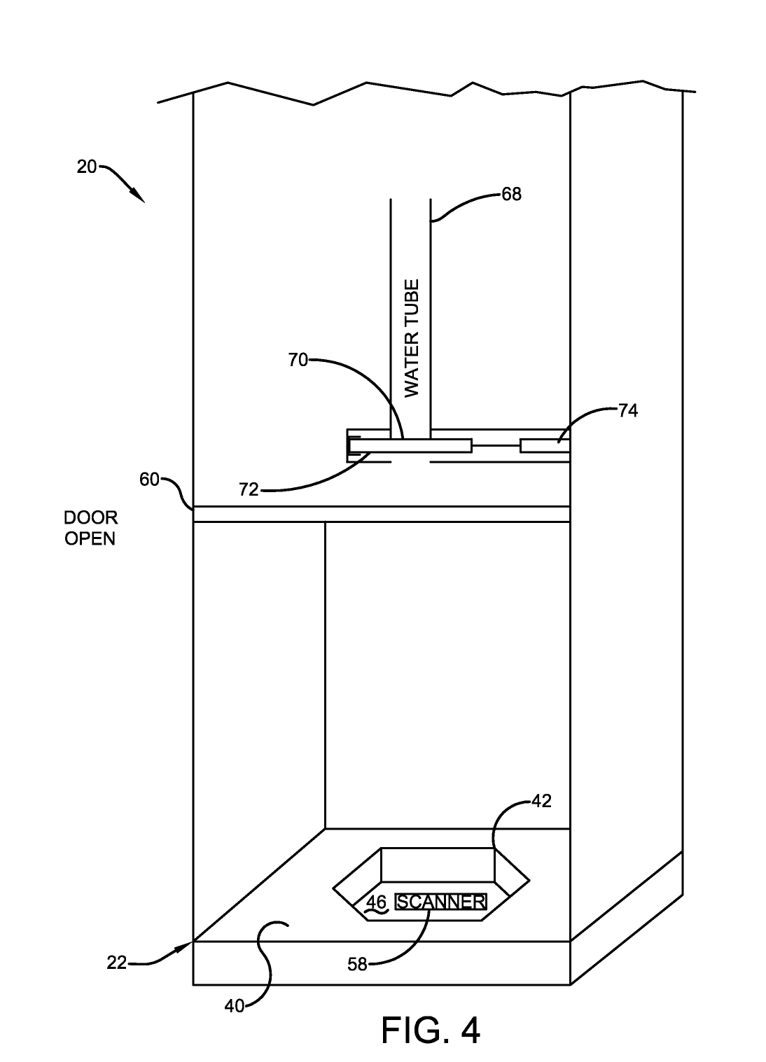

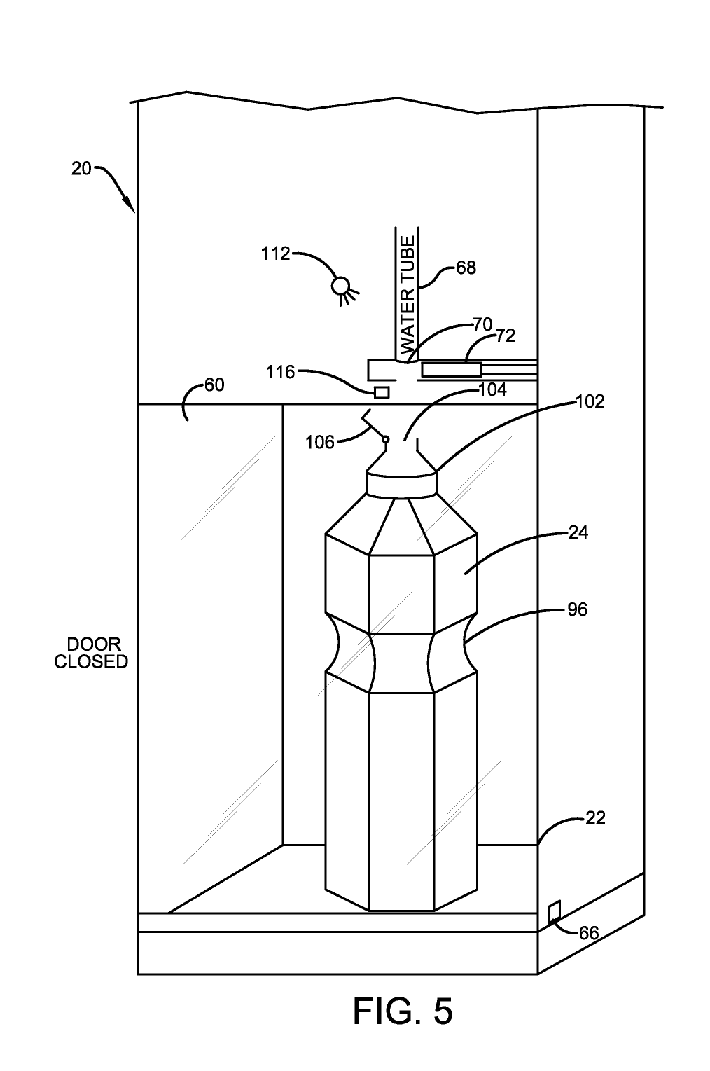

Referring to FIG. 4, a flexible water line 68 for supplying the water to refill the bottle 24 is positioned in the vending machine 20 just above the bottle refilling station 22. The water line 68 includes an outlet 70 that is aligned over a top opening 100 of the bottle 24 (FIG. 5) when the bottle is inserted into the recess 42 of the platform 40 of the bottle refilling station 22. A stainless steel slide gate 72 covers and seals the outlet 70 of the water line 68 to protect the water line 68 from contamination. A gate actuator 74 is operatively connected to the slide gate 72 and is operative to control movement of the gate 72 between a blocked position (FIG. 4) blocking the flow of water from the outlet 70 and an unblocked position unblocking the outlet 70 to allow water to flow out of the outlet 70. The gate actuator 74 may be an electrically actuated cylinder, solenoid or other suitable actuator. Upon the barcode scanner 58 reading the bar code 56 on bottle 24, the gate actuator 74 causes the slide gate 72 to slide away from the outlet (FIG. 5) to the unblocked position.

Referring to FIG. 6, the machine includes an interior 76 in which refillable water containers 78 are positioned. The interior may be accessible by a service door 80 (FIG. 1). The containers 78 may be of any volume such as the standard five gallon volume. The water in the containers 78 may be natural spring water or distilled water. Alternatively or in addition, the vending machine containers 78 may be filled with other types of liquids such as soda, juice, coffee, tea, or sports drinks for refilling bottles 24.

The containers 78 may be placed upon shelves 82 provided in the interior. In this exemplary embodiment, two shelves are positioned to divide the interior into three levels. Each shelf includes four containers 78. Of course any other suitable number of shelves or containers may be used. The containers 78 may be exchanged with other similar containers 78. For example, the containers 78 in the interior 76 and may be removed when empty and replaced with other containers filled with water. A water line 84 is fluidly connected to or plumbed from each of the containers to a reservoir 86 at the base of the machine. The reservoir 86 is filled with water from the containers 78. The containers 78 are located above the reservoir 86 so that the water flows into the containers by gravity. The reservoir 86 may have a volume capacity of of six gallons. An electric powered water pump 88 is fluidly connected to the reservoir 86 and operates to pump water from the reservoir 86 to the outlet 70 of the water supply line 68. The pump 88 operates after payment is accepted by the vending machine 20, the barcode 56 on the bottom end 52 of the bottle 24 is verified by the scanner 58, and the gate 72 is in the unblocked position. A check valve 90 is provided in an inlet 92 of the water line 84, which is fluidly connected to a respective outlet 94 of each container 78 to prevent water from back flowing into the container 78.

Referring to FIG. 7, the water bottle 24 is generally hexagonally shaped and includes a curved tapered grip portion 96 just above the middle of the container to aid in gripping the bottle. The water bottle 24 may be conveniently sized for travel by the consumer. The bottle may be a 20 ounce, a 12 ounce or other suitable bottle volume. As depicted in FIGS. 5 and 9, a removable lid 102 is threadily secured around the top of the bottle 24. The lid 102 has an opening 104 that is of larger size than the outlet 70 of the water line 68. The outlet 70 is aligned with the opening 104 when the lower portion 44 of the bottle 24 is seated in the recess 42 as seen in FIG. 5. A cover 106 is pivotally connected via a hinge 108 to an upstanding rim 110 surrounding the opening 104. The cover 106 can be selectively pivoted between a covered position covering the opening (see phantom lines in FIG. 9) and an uncovered position (FIGS. 5 and 9) away from the opening to expose the entire opening to the outlet. A reflective coating 112 coats the top side of the cover 106 to communicate to the machine as to whether the opening 104 is covered or exposed. In particular, when the cover 106 is in the covered position, the coating 112 will reflect light (e.g. infrared light) shining down from a light source 114 located above the lid to an optical sensor 116 also located above the lid 102. Upon receiving the light, the optical sensor 116 then sends a signal to the programmable logic controller 118 that the cover 106 is in the closed position. The controller 118 then sends a signal to the actuator 74 to prevent the gate 72 from moving to the unblock position and/or prevent the pump 88 from operating. When the cover 106 is in the open position, no light is reflected by the coating 112 to actuate the optical sensor 116 to send a signal to the controller 118 to prevent the gate 72 from moving to the unblock position and/or prevent the pump 88 from operating. The vending machine may alternatively be configured to refill containers other than bottles such as cups, mugs or glasses. The vending machine 20 may include a climate control system 120 (FIG. 6) that maintains the temperature of the interior between 39 and 42 degrees Fahrenheit.

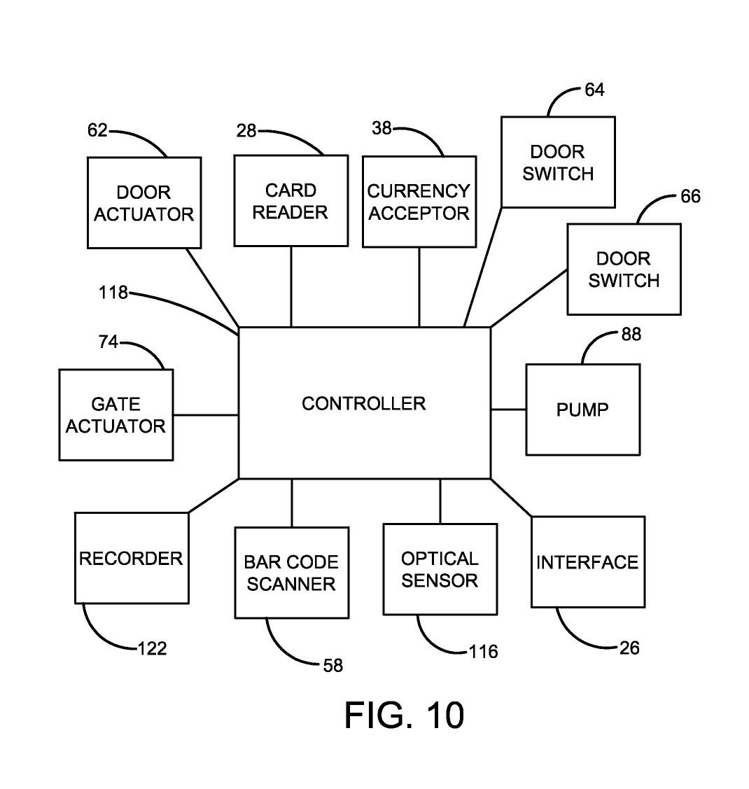

Referring to FIG. 10, the programmable logic controller 118 is provided to control the operation of the components of the vending machine 20. The controller 118 may be a processor, computer or circuitry that controls the operation of the components of the vending machine 20. The interface 26, sliding door actuator 62, gate actuator 74, card reader 28, currency acceptor 30, pump 88, bar code scanner 58, door switches 64, 66, and optical sensor 116 are operatively connected to the controller 118. A recorder 122 may also be operatively connected to the vending machine 20 to record vending activity. The recorder 122 may communicate this activity data to a remote location such as a terminal located at a corporate center or at a location of a vending partner. The activity data may be sent over an internet line or the wireless internet connection 34 to the remote location.

In operation, a user approaches the vending machine 20 to refill his or her water bottle 24 with the water. The interface 26 may display a message that prompts the user to enter payment to refill the water bottle 24. The message may also warn the user that only a particular type of water bottle 24 may be used by the vending machine 20 to refill the water. The user may pay by swiping or inserting a credit or debit card in the card reader 28 and/or by inserting cash into the currency acceptor 30. Upon receiving the correct payment, the card reader 28 and/or currency acceptor 30 sends a signal to the controller 118, which in turn sends a control signal to or otherwise causes the sliding door actuator 62 to move the door 60 upward to the open position as seen in FIG. 2A. The interface 26 may then display a message that prompts the user to place in the water bottle 24 into the recess 42. The user then places the water bottle 24 in the recess 42 in a position such that the bar code scanner 58 can scan and read the bar code 56. If the bar code scanner 58 does not detect a valid bar code, the scanner 58 may send a signal to the controller 118, which in turn may cause the interface 26 to display a message that the bottle 24 is not a bottle belonging to the set of bottles that the vending machine 20 will refill. The operation then stops and the vending machine 20 returns the money or credits the credit or debit card of the user. The controller 118 also receives a signal or no signal from the optical sensor to determine whether the cover 106 on the lid 102 is in the uncovered or covered position. If the controller 118 determines from the optical sensor 116 that the cover 106 is in the covered position, the controller causes the interface 26 to display a message indicating to the user that cover 106 is covered or not opened and stops the operation. The user can then take the bottle 24 out, move the cover 106 to the uncovered position and reposition the bottle 24 in the recess 42. The vending machine 20 may include a money return button for the user to operate to return his or her money, if the operation of the machine stops before it begins to refill the bottle 24 with water.

Upon reading a valid bar code 56, the bar code scanner 58 sends a signal to the controller 118 that the bar code 56 is valid. In response to a valid bar code signal and determination that the cover 106 is in the uncovered position, the controller 118 sends a signal to the door actuator 62 to move the door 60 in the closed position (i.e. close the door 60). In response to the signal by the lower door switch detecting that door 60 is in the closed position and the bar code 56 is valid, the controller 118 sends a signal to the gate actuator 74 to move the gate 72 to the unblocking position (i.e. open the gate). In response to the valid bar code signal, the signal that the door 60 is in the closed position, and the signal from the gate actuator 74 that the gate 72 is in the unblocked position, the controller 118 sends a signal to the pump 88 to operate the pump 88. The pump 88 operates to fill the bottle 24 with water from the reservoir 86 and stops operating by the controller 118 when the water is at a predetermined volume. The predetermined volume may be programmed in the memory of controller 118. After the bottle 24 is filled with water, the controller 118 causes the gate actuator 74 to close or move the gate 72 in the blocked position and then causes the door actuator 62 to move the door 60 in the open position. After the user removes the bottle, the controller 118 causes the door actuator to move the door to the close position. Alternatively, the interface 26 may prompt the user to pay after the barcode scanner 58 scans a valid code and the optical sensor determines that the cover 106 is opened in the uncovered position. In this case, once payment is received, the controller 118 causes the gate actuator 74 to open or move the gate 72 in the unblocked position and the pump 88 to operate to fill the bottle 24 with water from the reservoir 86.

The vending machine will be located in settings such as convenience stores, parks, learning institutions, and various other public and private settings. The vending machine may be conveniently located next to a vending machine or retail store that sells the water bottles that can be refilled with water by the vending machine. By having the same bottle be refilled with water, this vending machine reduces the environmental waste generated by the empty bottles and also appeals to the environmental concerns of the consumer. This maximizes health to the both the consumer and the environment.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A vending machine for refilling a bottle with liquid comprising:
a refilling station, wherein the refilling station is configured to receive and refill only bottles from a set of bottles having the same configuration with the liquid;
a liquid source for supplying the liquid;
a payment acceptor, wherein the payment acceptor is configured to accept payment to refill the bottle with the liquid from the liquid source;
wherein a respective bottle from the set of bottles is refilled with liquid from the liquid source when received by the filling station in response to the payment acceptor receiving payment to refill the bottle with liquid from the liquid source.

2. The vending machine of claim 1 including a controller, wherein the controller is operatively connected to the liquid source and payment acceptor, wherein the controller is operative to cause the liquid source to refill the bottle with the liquid in response to the payment acceptor receiving payment to refill the bottle with liquid from the liquid source.

3. The vending machine of claim 2 including a bottle detector, wherein the bottle detector is operative to verify that the bottle received by the filling station is from the set of bottles have the same configuration, wherein the bottle detector is operatively connected to the controller, wherein the controller is operative to cause the liquid source to refill the bottle with the liquid in response to the payment acceptor receiving payment to refill the bottle with liquid from the liquid source and in response to the bottle detector verifying that the bottle received by the filling station is from the set of bottles have the same configuration.

4. The vending machine of claim 2 wherein the bottle detector includes a barcode scanner, wherein the barcode scanner is operative to read barcodes provided only on the set of bottles having the same configuration.

5. The vending machine of claim 2 including a recorder, wherein the recorder is operatively connected to the controller, wherein the recorder is operative to record vending activity of the vending machine.

6. The vending machine of claim 6 wherein the recorder is operative to send vending activity data over a wireless internet connection.

7. The vending machine of claim 2 including a door, wherein the door moves between a closed position covering the refilling station and an open position enabling the bottle to be placed in the refilling station.

8. The vending machine of claim 7 including at least one door switch, wherein the at least one door switch is in operative connection with the door and the controller, wherein the at least one door switch is operative to detect the position of the door and send a signal to the controller indicative of the position of the door.

9. The vending machine of claim 7 including a bottle detector, wherein the bottle detector is operative to verify that the bottle received by the refilling station is from the set of bottles have the same configuration, wherein the bottle detector and the door are operatively connected to the controller, wherein the controller causes the door to move to a closed position in response to the bottle detector verifying that the bottle received by the refilling station is from the set of bottles have the same configuration.

10. The vending machine of claim 2 including an outlet located above the bottle when the bottle is place on the station, wherein the outlet is in fluid communication with the liquid source, wherein the outlet is configured to allow liquid from the liquid source to flow through the outlet and into the bottle, a gate operatively associated with the outlet, wherein the gate is operative to move between a blocked position blocking the flow of liquid from the outlet and an unblocked position unblocking the outlet to allow liquid to flow out of the outlet.

11. The vending machine of claim 10 including a pump, wherein the pump is operative to pump liquid from the liquid source to the outlet, a bottle detector, wherein the bottle detector is operative to verify that the bottle received by the refilling station is from the set of bottles have the same configuration,
a door, wherein the door moves between a closed position covering the refilling station and an open position enabling the bottle to be placed in the refilling station, at least one door position detector operatively connected to the controller, wherein the door position detector is operative to detect the position of the door and send a signal to the controller indicative of the position of the door,
wherein the pump, the bottle detector, the door, and the gate are operatively connected to the controller, wherein the controller causes the pump to operate in response to the gate being in the unblocked position, the bottle detector verifying that the bottle received by refilling station is from the set of bottles having the same configuration, and the door position detector detecting that the door is in the closed position.

12. The vending machine of claim 11 including a bottle detector, wherein the bottle detector is operative to verify that the bottle received by the refilling station is from the set of bottles having the same configuration, wherein the bottle detector and the gate are operatively connected to the controller, wherein the controller causes the gate to move to the unblocked position in response to the bottle detector verifying that the bottle received by the refilling station is from the set of bottles having the same configuration.

13. The vending machine of claim 12 including a door, wherein the door moves between a closed position covering the refilling station and an open position enabling the bottle to be placed in the refilling station, at least one door position detector, wherein the door position detector is in operative connection with the door and the controller, wherein the door position detector is operative to detect the position of the door and send a signal to the controller indicative of the position of the door, wherein the controller causes the gate to move to the unblocked position in response to the bottle detector verifying that the bottle received by refilling station is from the set of bottles having the same configuration and the door position detector detecting that the door is the closed position.

14. The vending machine of claim 1 wherein the liquid source includes a reservoir, wherein the reservoir is fluidly connected to a plurality of exchangeable containers, wherein each of the containers contains liquid, wherein the containers are operative to allow liquid in them to flow into the reservoir by gravity.

15. The vending machine of claim 1 including a bottle detector, wherein the bottle detector is operative to verify that the bottle received by the refilling station is from the set of bottles have the same configuration, a controller operatively connected to the liquid source and the bottle detector,
a cover, wherein the cover is operative to move between a covered position covering a fill opening in the bottle and an uncovered position uncovering the fill opening to allow liquid from the liquid source to flow into the bottle, wherein the controller is operative to cause the liquid from the liquid source to refill the bottle in response to a signal sent by the payment acceptor receiving payment to refill the bottle with liquid from the liquid source, the bottle detector verifying that the bottle received by the filling station is from the set of bottles have the same configuration, and the cover is in the uncovered position.

16. The vending machine of claim 1 wherein the liquid source comprises at least one exchangeable container containing natural spring water.

17. The vending machine of claim 1 wherein the refilling station includes a recess configured to receive the bottle, wherein the recess has a shape that matches the shape of at least a portion of the bottle, wherein the recess is sized such that the bottle snugly fits into the recess.

18. The vending machine of claim 17 wherein the recess and the at least portion of the bottle are hexagonally shaped.

19. The vending machine of claim 1 including a climate control system that maintains the temperature of the liquid in the liquid source between 39 and 42 degrees Fahrenheit.

20. The vending machine of claim 1 wherein the payment acceptor is configured to accept payment using one of a credit card and a debit card.
